(19) United States
(12) Patent Application Publication
(10) Pub. No.: US 2021/0368091 A1
(43) Pub. Date: Nov. 25, 2021

(54) WEARABLE CAMERA

(71) Applicant: CANON KABUSHIKI KAISHA, Tokyo (JP)

(72) Inventors: Yuichi Tomioka, Tochigi (JP); Takashi Morii, Kanagawa (JP); Satoshi Ishizu, Tokyo (JP); Shinya Omori, Tokyo (JP)

(21) Appl. No.: 17/320,518

(22) Filed: May 14, 2021

(30) Foreign Application Priority Data
May 22, 2020 (JP) 2020-089313

(51) Int. Cl. H04N 5/232; H04N 5/225; G03B 17/02

(52) U.S. Cl. CPC H04N 5/23206; H04N 5/23241; G03B 17/02; H04N 5/2252

(57) ABSTRACT

A wearable camera according to the present invention includes: an image pickup unit that obtains moving image data of an object; a detection unit that obtains detection data; a control unit that determines whether a wearer is in an abnormal situation based on the moving image data and the detection data and generates attribute tag data containing a determination clock time and details of abnormality when it is determined that the wearer is in an abnormal situation; a first communication unit that transmits first information to a server when the control unit determines that the wearer is in an abnormal situation; and a second communication unit that transmits second information containing the moving image data and having a greater amount of data than that of the first information to the server based on the attribute tag data.

### BACKGROUND OF THE INVENTION

### Field of the Invention

The present invention relates to a wearable camera.

### Description of the Related Art

There has been proposed a wearable camera for obviating crimes and accidents by using an image pickup unit and a communication unit to transmit a pickup image and the like to a guardian to notify the guardian that a wearer such as a child is in an abnormal situation including facing a dangerous situation, for example.

Japanese Patent Application Laid-Open No. 2016-130926 discloses a wearable camera that transmits information on surroundings of a wearer obtained by an image pickup unit, a calling unit, a location information obtainment unit, and an impact detection unit to a server.

The wearable camera disclosed in Japanese Patent Application Laid-Open No. 2016-130926 transmits an enormous amount of information containing all the obtained video information, sound information, and so on to the server through a communication network.

Conducting the process of transmitting such a large amount of information then requires a great amount of power consumption and processing time, leading to an increase in size due to a capacity increase in a battery, a reduction in the maximum operation time, and a degradation in throughput.

### SUMMARY OF THE INVENTION

In view of this, an object of the present invention is to provide a wearable camera that can suppress an increase in the power consumption and a degradation in throughput.

A wearable camera according to the present invention includes: an image pickup unit that obtains moving image data of an object; a detection unit that obtains detection data; a control unit that determines whether a wearer is in an abnormal situation based on the moving image data and the detection data and generates attribute tag data containing a determination clock time and details of abnormality when it is determined that the wearer is in an abnormal situation; a first communication unit that transmits first information to a server when the control unit determines that the wearer is in an abnormal situation; and a second communication unit that transmits second information containing the moving image data and having a greater amount of data than that of the first information to the server based on the attribute tag data.

Further features of the present invention will become apparent from the following description of exemplary embodiments with reference to the attached drawings.

### BRIEF DESCRIPTION OF THE DRAWINGS

FIG. 1A is a block diagram illustrating a configuration of a wearable camera according to the present invention;

FIG. 1B is a block diagram illustrating a configuration of a monitoring system including the wearable camera according to the present invention;

FIG. 2 is a flowchart indicating processing of transmitting first abnormality information by the wearable camera according to the present invention; and

FIG. 3 is a flowchart indicating processing of transmitting second abnormality information by the wearable camera according to the present invention.

### DESCRIPTION OF THE EMBODIMENTS

Hereinafter, a wearable camera (portable communication terminal device) according to this embodiment is described in detail with reference to the drawings.

The wearable camera according to this embodiment is a wearable camera having a function of capturing an image of surroundings of a wearer and a function of transmitting obtained data.

Hereinafter, a security system including the wearable camera according to this embodiment is also described.

There have been proposed various security systems that are for parents (guardians) to identify the location of their child (guarded person) on the way to school or cram school or for the safety checks and security of the child by attaching a communication terminal device (wearable terminal) having an image pickup function and a communication function to the child.

For example, there is disclosed a security system that transfers all data containing an image and the like obtained by the above-described wearable terminal to a server through a data communication network and analyzes the transferred data on the server to automatically operate a security buzzer and enable early discovery of a criminal.

However, since all the data obtained by the wearable terminal is transferred to the server through the data communication network in the above-described security system, it is required to transmit an enormous amount of the data containing video, sound data, and so on by the wearable terminal.

If the communication amount in the wearable terminal is increased, the power consumption for establishing the communication is accordingly increased.

Additionally, if the power consumption is increased, the operation time of the terminal is shortened, and meanwhile, for example, if the capacity of a battery is increased to attend to such an increase in the power consumption, the size of the terminal is enlarged.

Moreover, although it is possible in the above-described security system to obviate a crime by transferring the video, sound data, and so on to the server and then analyzing the data by the server, a reaction to the crime may be late since the transmission of such an enormous data requires time.

The communication speed of a terminal can be improved to some extent by using a communication package with a large capacity and high speed provided by a communication company.

However, the communication charges may be accordingly high, and the product's value of the security system may be low for a user who actually pays such expensive communication charges.

In view of this, an object of this embodiment is to provide a wearable camera and a security system that can obtain a particular effect of image obtainment and the promptness in times of emergency and can achieve a reduction in both the power consumption and the communication amount.

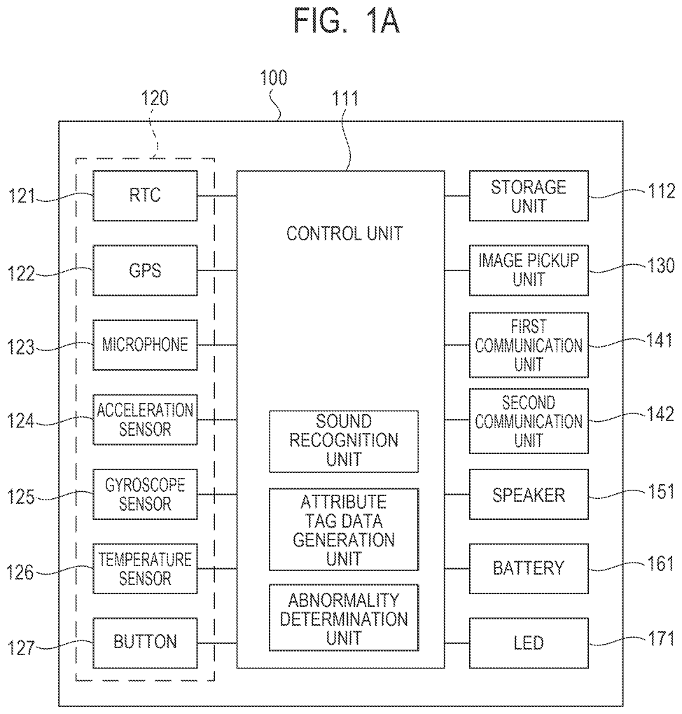

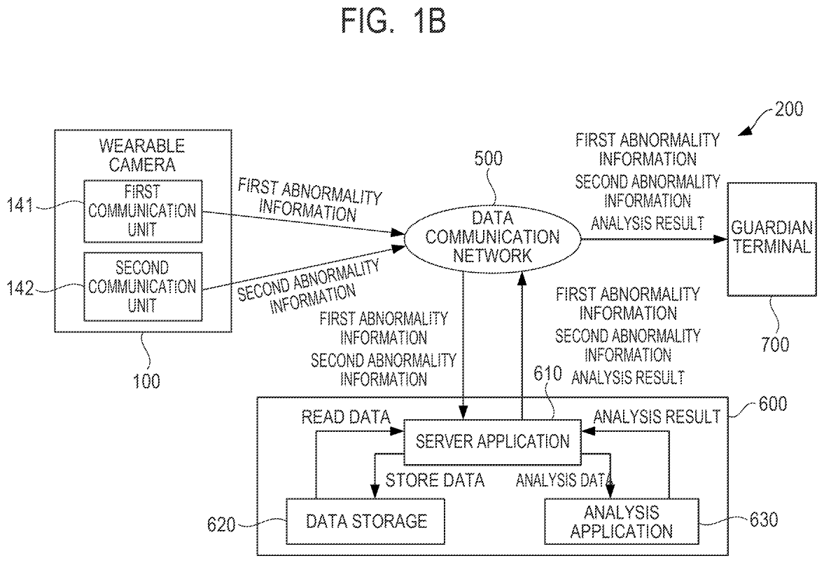

FIG. 1A is a block diagram illustrating a configuration of a wearable camera 100 (wearable camera for security) according to this embodiment.

FIG. 1B is a block diagram illustrating a configuration of a monitoring system 200 (security system) including the wearable camera 100 according to this embodiment.

As illustrated in FIG. 1A, the wearable camera 100 includes a control unit 111, a storage unit 112, a detection unit 120, an image pickup unit 130, a first communication unit 141, and a second communication unit 142.

The wearable camera 100 also includes a speaker 151, a battery 161, and a light emitting diode (LED) 171 as a condition display unit.

As illustrated in FIG. 1B, the monitoring system 200 according to this embodiment includes the wearable camera 100, which is a terminal for a wearer, a data communication network 500, a server 600, and a guardian terminal 700.

The image pickup unit 130 includes an image pickup lens and a solid image pickup element including a charge coupled device (CCD) image sensor, a complementary metal oxide semiconductor (CMOS) image sensor, or the like.

The image pickup unit 130 captures an image (performs image pickup) based on an instruction of image capturing transmitted from the control unit 111 and outputs image data and video data (moving image data) of an object that are obtained by the image capturing to the control unit 111.

The detection unit 120 as a data obtainment unit includes at least one sensor, specifically an RTC 121, a GPS 122, a microphone 123, an acceleration sensor 124, a gyroscope sensor 125, a temperature sensor 126, and a button 127.

The real time clock (RTC) 121 obtains a current clock time and outputs clock time data to the control unit 111.

The global positioning system (GPS) 122 obtains a current location of the wearable camera 100 and outputs location data to the control unit 111.

The microphone 123 obtains sound from an environment and a person surrounding the wearable camera 100 and outputs sound data to the control unit 111.

The acceleration sensor 124 obtains an acceleration of the wearable camera 100 and outputs acceleration data to the control unit 111.

The gyroscope sensor 125 obtains a posture of the wearable camera 100 and outputs posture data to the control unit 111.

The temperature sensor 126 obtains a temperature around the wearable camera 100 and outputs temperature data to the control unit 111.

The control unit 111 can thus obtain data (information, detection data) on the current clock time, the current location, the acceleration, the posture, the surrounding sound and temperature of the wearable camera 100.

When the button 127 is pressed by the wearer of the wearable camera 100, the button 127 outputs a signal to notify of the pressing to the control unit 111.

The configuration is not limited to the above, and the detection unit 120 may further include a sensor similar to the above sensors.

Specifically, the detection unit 120 may further include a sensor for obtaining data on the environment around the wearer himself/herself and the state of the wearer himself/herself, such as an actinometer, a pulsimeter, a stereo camera, an infrared camera, or the like.

The first communication unit 141 is a communication module that transmits the data transmitted from the control unit 111 to a data communication network 500 through a wireless communication system according to an instruction transmitted from the control unit 111.

The first communication unit 141 herein is a communication module that is, for example, compatible with long term evolution-machine type communications (LTE-machine type communications, LTE-MTC) (registered trademark) of low-power wide-area (LPWA) carried out between devices.

The second communication unit 142 is a communication module that transmits the data transmitted from the control unit 111 to the data communication network 500 through a wireless communication system according to an instruction transmitted from the control unit 111.

The second communication unit 142 herein is a communication module that is, for example, compatible with a wireless local area network (LAN) that is Wireless Fidelity (Wi-Fi) (registered trademark).

Specifically, after the second communication unit 142 transmits the data to a predetermined router through the Wi-Fi, the data is transmitted from the predetermined router to the data communication network 500 through an Ethernet line.

A communication method for the first communication unit 141 and the second communication unit 142 is not limited to the above. For example, a wired communication method may be used as the communication method for the second communication unit 142.

Preferably, the maximum communication speed of the second communication unit 142 is greater than that of the first communication unit 141.

As described above, the wearable camera 100 according to this embodiment includes the second communication unit 142 in addition to the first communication unit 141.

As illustrated in FIG. 1B, the first communication unit 141 and the second communication unit 142 transmit first abnormality information and second abnormality information, respectively, to a server application 610 included in the server 600 through the data communication network 500 as described in detail below.

In the monitoring system 200 according to this embodiment, the server 600 is provided with the server application 610, a data storage 620, and an analysis application 630.

The server application 610 is a reception part that receives the data transmitted from the first communication unit 141 and the second communication unit 142.

The server application 610 transmits analysis data to the analysis application 630, instructs the analysis application 630 to execute data analysis, and also receives an analysis result from the analysis application 630.

Additionally, the server application 610 transmits data to be stored to the data storage 620, instructs the data storage 620 to store the data, and also reads the stored data from the data storage 620.

Moreover, the server application 610 transmits the first abnormality information and the second abnormality information and transmits the analysis result of the data and a notification indicating that the wearer is in an abnormal situation to the guardian terminal 700 (reception unit) through the data communication network 500.

Furthermore, the server application 610 transmits the data and makes a notification to the wearable camera 100 of the wearer.

The data storage 620 stores original data of a moving image contained in the second abnormality information, metadata and details of the abnormality obtained by the detection unit 120, and the like.

The analysis application 630 analyzes the data received from the server application 610. Specifically, the analysis application 630 analyzes image data to identify a person or an action shown in the image or analyzes sound data to identify sound from an accident, speaking by a suspicious person, a scream of the wearer, and the like.

As illustrated in FIG. 1A, the control unit 111 includes an abnormality determination unit that determines whether the wearer is in an abnormal situation based on the data obtained by the detection unit 120.

The abnormal situation herein includes, for example, a situation where the wearer is involved in a traffic accident, a situation where the wearer has a health problem, a situation where the wearer becomes a crime victim, and the like.

Additionally, a situation where the danger level of the wearer is higher than usual such as when there is a high possibility that the wearer becomes a crime victim or is involved in an accident can be also defined as the abnormal situation.

The situation where there is a high possibility that the wearer becomes a crime victim herein includes, for example, a situation where a suspicious person has a crime predictive action, such as “following” “staring” and “speaking” to a child.

Statistic data shows that the main purpose of such actions of a suspicious person is to look for a target of crime, and many of the children who encountered such crime predictive actions are likely to actually be a crime victim.

The situation where there is a high possibility that the wearer is involved in an accident includes, for example, a situation where the child does not observe traffic rules, a situation where the wearer is distracted, and the like.

Specifically, the situation where there is a high possibility that the wearer is involved in an accident includes that the child does not stop at a location of temporary halt, does not check safety at an intersection, ignores a traffic light, exceeds the speed limit in a place with many people such as a shopping street, and the like.

Other than the above, for example, situations where the child is not on a normal school route or a route to a cram school and where the child enters a dangerous area such as a railroad crossing may indicate that there is a high possibility that the child is involved in an accident or could be already abducted and may be included in the situations where the danger level of the wearer is higher than usual.

It is needless to say that the situation where the danger level of the wearer is higher than usual is not limited to the above-described situations.

In the wearable camera 100 according to this embodiment, the abnormality determination unit is provided in the control unit 111; however, the configuration is not limited to the above, and the abnormality determination unit may be provided separately.

As illustrated in FIG. 1A, the control unit 111 includes an attribute tag data generation unit that generates attribute tag data. When the abnormality determination unit in the control unit 111 determines that the wearer is in the abnormal situation, the attribute tag data generation unit generates attribute tag data containing an identification (ID) of the wearable camera 100, the clock time obtained by the RTC 121, the location information obtained by the GPS 122, and the details of the abnormality when the determination is made.

According to the thus-generated attribute tag data, it is possible to associate the clock time, the moving image, and the detection signal when the wearer is in the abnormal situation with each other and to store the generated attribute tag data to the storage unit 112.

The attribute tag data generated by the wearable camera 100 according to this embodiment is not limited to the above, and the attribute tag data may be anything as long as the attribute tag data contains, for example, the clock time and the details of the abnormality when the wearer is in the abnormal situation.

Thus, it is possible to analyze the moving image and the detection signal contained in the second abnormality information that is transmitted by the second communication unit 142 to the server 600 as described later while associating the moving image and the detection signal with the clock time and the details of the abnormality contained in the generated attribute tag data.

As illustrated in FIG. 1A, the control unit 111 includes a sound recognition unit that recognizes sound contained in the sound data obtained by the microphone 123.

Thus, for example, it is possible to obtain sound around the wearer by the microphone 123 and to determine whether a keyword set in advance is detected from the obtained sound data.

Next, processing by the wearable camera 100 according to this embodiment when it is determined that the wearer is in the abnormal situation is described.

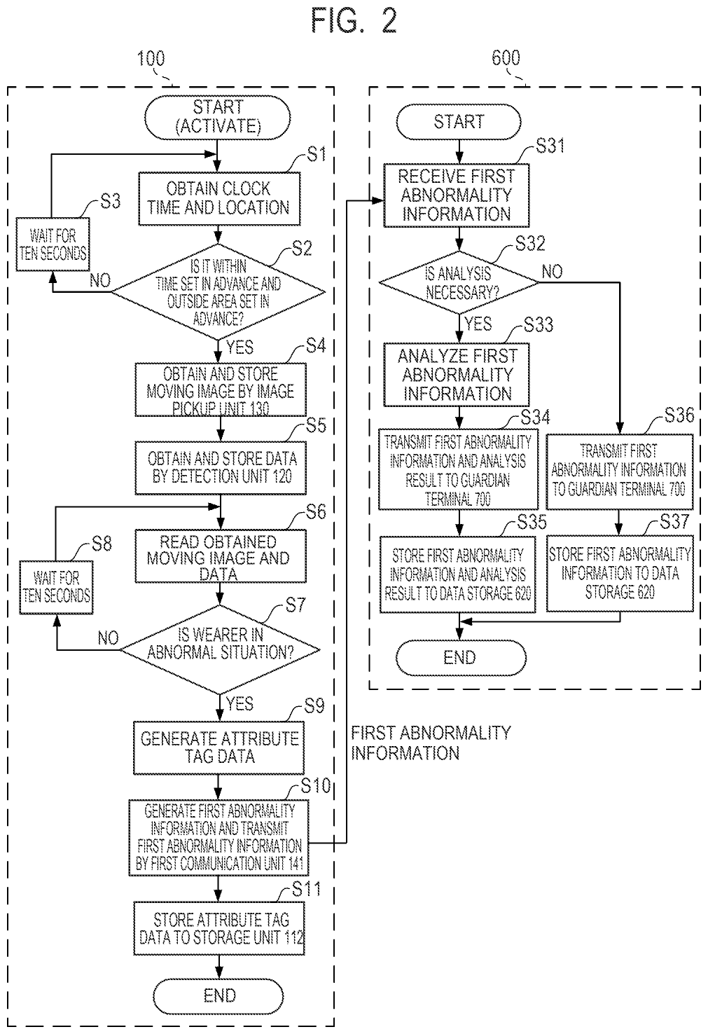

FIG. 2 is a flowchart indicating processing of transmitting the first abnormality information by the wearable camera 100 according to this embodiment when it is determined that the wearer is in the abnormal situation.

As illustrated in FIG. 2, when the wearable camera 100 is activated, the wearable camera 100 obtains information on the current clock time and location from the RTC 121 and the GPS 122 (step S1).

Next, it is determined whether the current clock time obtained in step S1 is within time set in advance (for example, clock time for commuting, clock time for going cram school, after school, and the like) and also whether the current location is outside of an area set in advance (for example, home, school, cram school, after-school childcare, and the like) (step S2).

When the current clock time is within the set time but the current location is not outside of the set area (No in step S2), the wearable camera 100 waits for ten seconds (step S3), the process returns to step S1, and the wearable camera 100 obtains the information on the current clock time and location again.

On the other hand, when the current clock time is within the set time and the current location is outside of the set area (Yes in step S2), the wearable camera 100 activates the image pickup unit 130 to start obtainment of the moving image and store the obtained moving image to the storage unit 112 sequentially (step S4).

Next, the wearable camera 100 activates the predetermined sensor provided in the detection unit 120 to start obtainment of the data by the predetermined sensor and store the obtained data to the storage unit 112 sequentially (step S5).

Next, the control unit 111 reads the moving image and the data obtained and stored to the storage unit 112 in steps S4 and S5 (step S6) to determine whether the wearer is in the abnormal situation (step S7).

In this process in step S7, it is determined whether the thus-read moving image and data fall under the conditions indicated in Table 1 below.

TABLE 1

| Abnormality | | Device used for | |
|---|---|---|---|
| condition | Details of abnormality | determination | Condition for determining it is abnormal situation |
| A | Collision, falling down, attack | Acceleration sensor | Acceleration equal to or more than threshold is detected |
| | | 124 | |
| B | Entering to outside of normal | GPS 122 | Current location is not within area set in advance |
| | activity area | | |
| C | Suspicious speaking | Microphone 123 | Keyword set in advance (“Let me give you a ride.” and the |
| | (suspicious attractive words) | | like) is detected |
| D | Suspicious speaking (one- | Microphone 123 | Voice of predetermined person is continuously detected but |
| | way speaking) | | no voice of wearer is detected for 10 or more seconds |
| E | Particular sound indicating | Microphone 123 | Particular environmental sound (sound of brakes, scream, |
| | possibility of accident or | | angry shout, and the like) is detected |
| | crime | | |
| F | Predictive action of | Image pickup unit | Predetermined person is shown in image after lapse of |
| | suspicious person “following” | 130/RTC 121 | predetermined time |
| | “staring” | | |
| G | Predictive action of | Image pickup unit | Predetermined person is shown in image after moving by |
| | suspicious person “following” | 130/GPS 122 | predetermined distance |
| H | Lonely | Image pickup unit | Only one person is shown around wearer in image |
| | | 130/RTC 121 | |
| I | SOS button is pressed | Button 127 | Input to button (pressing, sliding, and the like) is detected |
| J | High temperature | Temperature sensor | Temperature equal to or more than threshold is detected |
| | environment | 126 | |
| K | Wearer is crouching or lying | Gyroscope sensor | Posture set in advance is detected continuously for time equal |
| | | 125/RTC 121 | to or more than threshold |
| L | Dangerous action for traffic | GPS 122/acceleration | It is detected that current location is place set in advance and |
| | “no temporary halt, no safety | sensor 124 | wearer does not stop three seconds or more. |
| | check” | | |

When it is determined that the wearer is not in the abnormal situation based on the conditions indicated in Table 1 (No in step S7), the wearable camera 100 waits for ten seconds (step S8), the process returns to step S6, and the wearable camera 100 reads the latest moving image and data stored in the storage unit 112 again. Then, whether the wearer is in the abnormal situation is determined again in step S7.

On the other hand, when it is determined that the wearer is in the abnormal situation based on the conditions indicated in Table 1 (Yes in step S7), the attribute tag data generation unit provided in the control unit 111 generates the attribute tag data (step S9).

The attribute tag data generated by the attribute tag data generation unit in this process contains an abnormality code corresponding to each of the abnormality conditions in Table 1, the ID of the wearable camera 100, the clock time (determination clock time), and the location when it is determined that the wearer is in the abnormal situation, as indicated in Table 2 below.

TABLE 2

| Abnormality | attribute tag data | | | |
|---|---|---|---|---|
| condition | Data 1 | Data 2 | Data 3 | Data 4 |
| A | Abnormality | Clock time | ID | Location |
| | code 1 | | | information |
| B | Abnormality | Clock time | ID | Location |
| | code 2 | | | information |
| C | Abnormality | Clock time | ID | Location |
| | code 3 | | | information |
| D | Abnormality | Clock time | ID | Location |
| | code 4 | | | information |
| E | Abnormality | Clock time | ID | Location |
| | code 5 | | | information |
| F | Abnormality | Clock time | ID | Location |
| | code 6 | | | information |
| G | Abnormality | Clock time | ID | Location |
| | code 7 | | | information |
| H | Abnormality | Clock time | ID | Location |
| | code 8 | | | information |
| I | Abnormality | Clock time | ID | Location |
| | code 9 | | | information |
| J | Abnormality | Clock time | ID | Location |
| | code 10 | | | information |
| K | Abnormality | Clock time | ID | Location |
| | code 11 | | | information |
| L | Abnormality | Clock time | ID | Location |
| | code 12 | | | information |

The first communication unit 141 then generates the first abnormality information based on the attribute tag data generated in step S9 and transmits the first abnormality information to the server 600 through the data communication network 500 (step S10). Additionally, the attribute tag data generated in step S9 is stored to the storage unit 112 (step S11).

The first abnormality information (first information) transmitted from the wearable camera 100 according to this embodiment in this process contains the abnormality code, the ID of the wearable camera 100, the clock time, and the location obtained from the attribute tag data and predetermined data corresponding to each of the abnormality codes, as indicated in Table 3 below.

TABLE 3

| Abnormality | First abnormality information | | | | |
|---|---|---|---|---|---|
| condition | Data 1 | Data 2 | Data 3 | Data 4 | Data 5 |
| A | Abnormality | Clock | ID | Location | Maximum value of |
| | code 1 | time | | information | acceleration in each of |
| | | | | | detected directions |
| B | Abnormality | Clock | ID | Location | One piece of static image |
| | code 2 | time | | information | |
| C | Abnormality | Clock | ID | Location | Detected keyword |
| | code 3 | time | | information | |
| D | Abnormality | Clock | ID | Location | Part of detected sound data |
| | code 4 | time | | information | |
| E | Abnormality | Clock | ID | Location | Part of detected sound data |
| | code 5 | time | | information | |
| F | Abnormality | Clock | ID | Location | One piece of static image |
| | code 6 | time | | information | |
| G | Abnormality | Clock | ID | Location | One piece of static image |
| | code 7 | time | | information | |
| H | Abnormality | Clock | ID | Location | One piece of static image |
| | code 8 | time | | information | |
| I | Abnormality | Clock | ID | Location | One piece of static image |
| | code 9 | time | | information | |
| J | Abnormality | Clock | ID | Location | Detected temperature |
| | code 10 | time | | information | |
| K | Abnormality | Clock | ID | Location | Detected posture |
| | code 11 | time | | information | |
| L | Abnormality | Clock | ID | Location | One piece of static image |
| | code 12 | time | | information | |

The wearable camera 100 according to this embodiment transmits the first abnormality information in order to promptly notify the guardian and the like of the abnormality of the wearer as a first report or in order to determine the data received by the server application 610 included in the server 600 and promptly give advice or bring attention to the wearer.

For this purpose, in the wearable camera 100 according to this embodiment, the first abnormality information contains only the bare minimum contents so that the guardian and the server application 610 can promptly determine the situation of the wearer.

Accordingly, the reduced amount of data contained in the first abnormality information allows for less time lag, and this makes it possible to promptly transmit the data.

For example, when there is a high possibility that a suspicious person is following the wearer, or when it is determined that the abnormality condition F or G is satisfied, one piece of static image from the obtained moving image in which the suspicious person is shown is appended to the first abnormality information as the predetermined data, as indicated in Table 3.

Otherwise, when there is a high possibility that a suspicious person speaks to the wearer, or when it is determined that the abnormality condition D is satisfied, sound data of few seconds cut out from a sound file of the suspicious person is appended to the first abnormality information as the predetermined data.

With the thus-generated first abnormality information containing the predetermined data being transmitted, the guardian and the server application 610 can make a more proper reaction.

When there is a high possibility that the wearer is hit by a vehicle, or when it is determined that the abnormality condition A is satisfied, only the maximum instantaneous acceleration obtained by the acceleration sensor 124 in the collision is appended to the first abnormality information.

With the thus-generated first abnormality information containing the predetermined data being transmitted, it is possible to determine the severity of the accident, the degree of the possibility of false detection, and the like.

As described above, in the wearable camera 100 according to this embodiment, the first abnormality information contains the abnormality code corresponding to each of the abnormality conditions in Table 1, the ID of the wearable camera 100, the clock time, and the location and the predetermined data corresponding to each of the abnormality codes when it is determined that the wearer is in the abnormal situation.

However, the first abnormality information is not limited to the above, and as long as the first abnormality information contains at least the abnormality code, or the details of the abnormality, and the clock time when it is determined that the wearer is in the abnormal situation, the guardian can promptly recognize the situation of the wearer. That is, it is possible to obtain the effects of this embodiment sufficiently.

When the server application 610 in the server 600 receives the first abnormality information transmitted from the first communication unit 141 (step S31), it is determined whether it is necessary to analyze the first abnormality information (step S32).

When it is determined that it is necessary to analyze the first abnormality information (Yes in step S32), the analysis application 630 analyzes the first abnormality information (step S33), and the contents of the first abnormality information and the analysis result are transmitted to the guardian terminal 700 (step S34). Thereafter, the first abnormality information and the analysis result are stored to the data storage 620 (step S35).

On the other hand, when it is determined that it is unnecessary to analyze the first abnormality information (No in step S32), the first abnormality information is transmitted to the guardian terminal 700 (step S36), and the first abnormality information is stored to the data storage 620 (step S37).

In the wearable camera 100 according to this embodiment, when it is determined that the wearer is in the abnormal situation, the first communication unit 141 promptly transmits the first abnormality information to the server application 610 through the data communication network 500 as described above, and then the second communication unit 142 transmits the second abnormality information on the determination.

The second abnormality information (second information) herein contains more detailed data than that of the first abnormality information, and the first abnormality information is transmitted for the prompt information notification, whereas the second abnormality information is transmitted for more precise detection of the foretaste of crime and accident.

For example, the second abnormality information contains original data of the moving image, the metadata obtained by the detection unit 120, and the like before or after the clock time when it is determined that the wearer is in the abnormal situation by a predetermined time, which are not contained in the first abnormality information, and the amount of data in the second abnormality information is greater than that in the first abnormality information.

Statistic data shows that a criminal of a crime against children before actually committing the crime is likely to look for a location for the crime and a target of the crime and is likely to have the crime predictive action (for example, staring, following, and speaking).

Since such actions occur few minutes, few hours, or few days before the clock time of the crime, and the approach and contact to the child are less as going back farther in time, the definiteness as the predictive action becomes less, and it becomes more difficult to make a determination.

In view of this, in the wearable camera 100 according to this embodiment, the second abnormality information is used in order to determine such predictive actions, from which it is difficult to determine whether the person is actually suspicious although there is enough time before the actual crime.

Additionally, not only for the crime against children but also for the traffic accidents of children, there are many cases where a child is involved in a traffic accident after the child had predictive actions such as that the child does not observe traffic rules regularly and that the child does not sufficiently check vehicles and traffic lights on regular basis.

In view of this, it is possible to obviate a traffic accident if, for example, a violation of the traffic rules by the child on that day can be detected and notified of after the child returns home, although it is not in real-time.

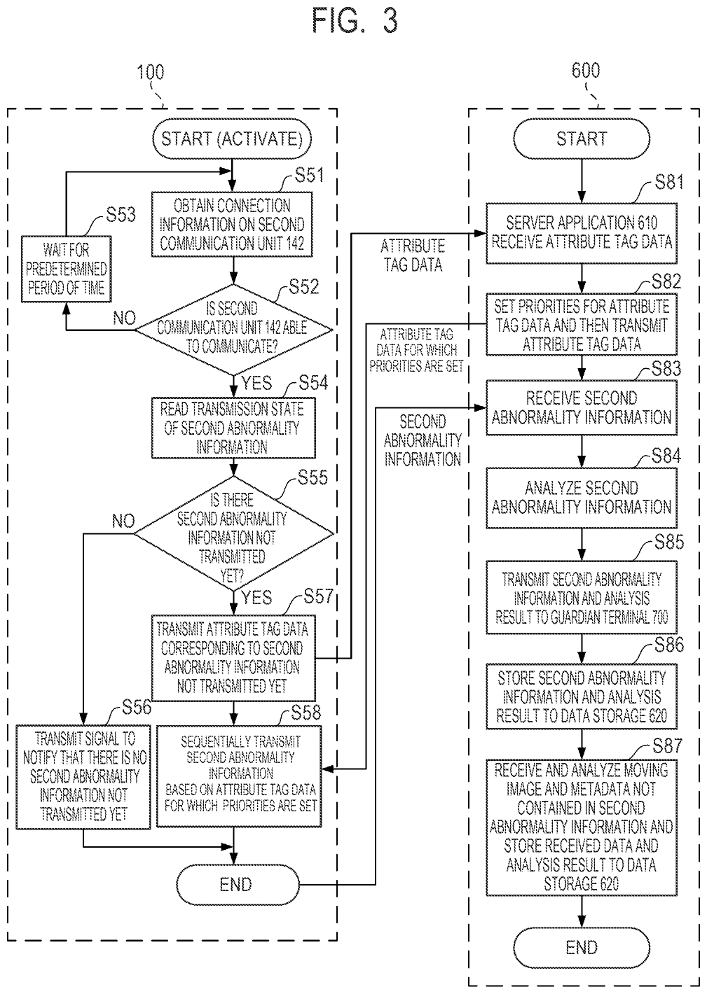

FIG. 3 is a flowchart indicating processing of transmitting the second abnormality information by the wearable camera 100 according to this embodiment when it is determined that the wearer is in the abnormal situation.

As illustrated in FIG. 3, when the wearable camera 100 is activated, the wearable camera 100 obtains connection information on the second communication unit 142 (step S51) and determines whether the second communication unit 142 is able to communicate (step S52).

When the second communication unit 142 is unable to communicate (No in step S52), the wearable camera 100 waits for a predetermined time (step S53), the process returns to step S51, and the wearable camera 100 obtains the connection information on the second communication unit 142 again.

On the other hand, when the second communication unit 142 is able to communicate (Yes in step S52), the transmission state of the second abnormality information corresponding to the attribute tag data generated when it is determined that the wearer is in the abnormal situation is read from the storage unit 112 (step S54).

Then, it is determined whether there is the second abnormality information not transmitted by the second communication unit 142 (step S55).

When there is no second abnormality information not transmitted by the second communication unit 142, or when all pieces of the second abnormality information stored in the storage unit 112 are already transmitted (No in step S55), a notification of that there is no new event where the wearer encountered the abnormal situation is transmitted from the second communication unit 142 (step S56), and the processing ends.

On the other hand, when there is the second abnormality information not transmitted by the second communication unit 142 (Yes in step S55), the attribute tag data corresponding to each piece of the second abnormality information not transmitted by the second communication unit 142 is transmitted to the server 600 through the data communication network 500 (step S57).

Next, the server application 610 provided in the server 600 receives the attribute tag data transmitted from the second communication unit 142 in step S57 (step S81).

The server application 610 then compares the attribute tag data to set priorities for the attribute tag data in descending order according to the danger level or the emergency level and transmits the attribute tag data for which the priorities are set to the second communication unit 142 (step S82).

In the wearable camera 100 according to this embodiment, although the second communication unit 142 is able to transmit an enormous amount of data, when a large number of the abnormal situations occur in one day, the amount of data that should be transmitted from the second communication unit 142 to the server application 610 through the data communication network 500 is increased accordingly.

Thus, when all the data is transmitted to the server 600, it takes a long time until the analysis application 630 completes the analysis.

Additionally, the frequency of occurrence of an event indicating that the wearer encountered the abnormal situation is likely to be higher as the danger level is lower.

Under this circumstance, it is undesirable that an event indicating a foretaste leading to a serious crime is buried in such events of low danger level, and the notification to the guardian is delayed consequently.

In view of this, in the monitoring system 200 according to this embodiment, the priorities are set such that processing of the second abnormality information corresponding to an event of higher danger level and emergency level takes priority.

In the monitoring system 200 according to this embodiment, the priorities are set as described above by the server application 610 provided in the server 600; however, the configuration is not limited to the above, and the priorities may be set as described above by the wearable camera 100.

Next, the second communication unit 142 sequentially transmits the second abnormality information not transmitted yet to the server 600 based on the attribute tag data for which the priorities are set that is transmitted from the server application 610 in step S82 (step S58), and the processing ends.

The server application 610 then receives the second abnormality information transmitted from the second communication unit 142 in step S58 (step S83) and causes the analysis application 630 to analyze the received second abnormality information (step S84).

Next, the server application 610 transmits the contents of the second abnormality information and the analysis result obtained from the analysis application 630 to the guardian terminal 700 (step S85) and also stores the second abnormality information and the analysis result to the data storage 620 (step S86).

The second abnormality information transmitted from the wearable camera 100 according to this embodiment in this process contains the abnormality code, the ID of the wearable camera 100, the clock time, and the location obtained from the attribute tag data, as indicated in Table 4 below.

Additionally, the second abnormality information contains the original data of the moving image and the metadata obtained by the detection unit 120 before or after the clock time when it is determined that the wearer is in the abnormal situation by a predetermined time, as indicated in Table 4 below.

TABLE 4

| Abnormality | Second abnormality information | | | | | |
|---|---|---|---|---|---|---|
| condition | Data 1 | Data 2 | Data 3 | Data 4 | Data 5 | Data 6 |
| A | Abnormality | Clock | ID | Location | Moving image data during five | Metadata on acceleration in each |
| | code 1 | time | | information | minutes before and after | direction during five minutes |
| | | | | | abnormality determination clock | before and after abnormality |
| | | | | | time | determination clock time |
| B | Abnormality | Clock | ID | Location | Moving image data in and during | Transition data of location |
| | code 2 | time | | information | five minutes before and after | information in and during five |
| | | | | | staying outside of area set in | minutes before and after staying |
| | | | | | advance | outside of area set in advance |
| C | Abnormality | Clock | ID | Location | Moving image data during five | — |
| | code 3 | time | | information | minutes before and after | |
| | | | | | abnormality determination clock | |
| | | | | | time | |
| D | Abnormality | Clock | ID | Location | Moving image data during five | — |
| | code 4 | time | | information | minutes before and after | |
| | | | | | abnormality determination clock | |
| | | | | | time | |
| E | Abnormality | Clock | ID | Location | Moving image data during five | — |
| | code 5 | time | | information | minutes before and after | |
| | | | | | abnormality determination clock | |
| | | | | | time | |
| F | Abnormality | Clock | ID | Location | Moving image data from clock time | — |
| | code 6 | time | | information | when predetermined person is | |
| | | | | | shown for first time to clock time | |
| | | | | | when predetermined person is | |
| | | | | | shown for last time | |
| G | Abnormality | Clock | ID | Location | Moving image data from clock time | — |
| | code 7 | time | | information | when predetermined person is | |
| | | | | | shown for first time to clock time | |
| | | | | | when predetermined person is | |
| | | | | | shown for last time | |
| H | Abnormality | Clock | ID | Location | Moving image data during five | — |
| | code 8 | time | | information | minutes before and after | |
| | | | | | abnormality determination clock | |
| | | | | | time | |
| I | Abnormality | Clock | ID | Location | Moving image data during five | Metadata on button input during |
| | code 9 | time | | information | minutes before and after | five minutes before and after |
| | | | | | abnormality determination clock | abnormality determination clock |
| | | | | | time | time |
| J | Abnormality | Clock | ID | Location | Static image data of every one | Metadata on temperature during |
| | code 10 | time | | information | minutes during five minutes before | five minutes before and after |
| | | | | | and after abnormality | abnormality determination clock |
| | | | | | determination clock time | time |
| K | Abnormality | Clock | ID | Location | Moving image data during five | Transition data of posture during |
| | code 11 | time | | information | minutes before and after | five minutes before and after |
| | | | | | abnormality determination clock | abnormality determination clock |
| | | | | | time | time |
| L | Abnormality | Clock | ID | Location | Moving image data during five | — |
| | code 12 | time | | information | minutes before and after | |
| | | | | | abnormality determination clock | |
| | | | | | time | |

For example, when there is a high possibility that a suspicious person is following the wearer, or when it is determined that the abnormality condition F or G is satisfied, moving image data from a clock time when a predetermined person is shown for the first time to a clock time when the predetermined person is shown for the last time is appended to the second abnormality information, as indicated in Table 4.

Otherwise, when there is a high possibility that a suspicious person speaks to the wearer, or when it is determined that the abnormality condition C or D is satisfied, moving image data during five minutes before and after the abnormality determination clock time is appended to the second abnormality information, as indicated in Table 4.

With the second abnormality information to which the moving image data is thus-appended being transmitted, the guardian and the server application 610 can make a more proper reaction.

When there is a high possibility that the wearer is hit by a vehicle, or when it is determined that the abnormality condition A is satisfied, metadata on an acceleration in each direction during five minutes before and after the abnormality determination clock time is also appended to the second abnormality information in addition to the moving image data during five minutes before and after the abnormality determination clock time, as indicated in Table 4.

With the second abnormality information to which the moving image data and the metadata are thus-appended being transmitted, it is possible to determine the severity of the accident, the degree of the possibility of false detection, and the like.

As it can be seen from Tables 3 and 4, making the data appended to each of the first abnormality information and the second abnormality information different from each other depending on the details of the abnormality makes it possible to suppress unnecessary increase in the amount of data and to make an efficient abnormality determination.

Additionally, as it can be seen from Tables 2 to 4, appending the data contained in the generated attribute tag data directly to each of the first abnormality information and the second abnormality information simplifies the processing.

However, the configuration is not limited to the above, and any configuration may be applied, as long as at least the clock time when it is determined that the wearer is in the abnormal situation and the details of the abnormality, or the abnormality code, out of the data contained in the attribute tag data are appended to the first abnormality information and the second abnormality information.

Next, the server application 610 receives the original data of the moving image and the metadata obtained by the detection unit 120 that are not contained in the second abnormality information, causes the analysis application 630 to analyze the received data, and stores the received data and the analysis result to the data storage 620 (step S87).

The processing in step S87 is executed for the following reasons.

In the monitoring system 200 according to this embodiment, it is possible to associate a plurality of pieces of information on the wearer over a plurality of days with each other and to associate information obtained by the wearable camera 100 of the wearer with information obtained by a wearable camera of another wearer each other.

Consequently, it is possible to detect all the abnormal situations of the wearer and all the crime predictive actions with a high degree of accuracy.

Specifically, the original data of the moving image and the metadata obtained by the detection unit 120 not contained in the second abnormality information, which are obtained by the wearable camera 100, are also transmitted to the server 600 to be analyzed and stored for sharing the data.

Consequently, for example, when a person is shown a predetermined number of times or more in a plurality of moving images of different places obtained by wearable cameras of a plurality of wearers, it is possible to register the person as a person to watch out for to a predetermined database to notify the guardian.

Additionally, when a person is shown a predetermined number of times or more in a plurality of moving images obtained by the wearable camera 100 over a plurality of days, it is possible to register the person as a person to watch out for to a predetermined database to improve the accuracy for determining the abnormal situation of the wearer.

In the monitoring system 200 according to this embodiment, the determination accuracy is improved by appending the original data of the moving image and the metadata obtained by the detection unit 120 before or after a predetermined time from the clock time when it is determined that the wearer is in the abnormal situation to the second abnormality information.

However, the configuration is not limited to the above, and it is possible to obtain the effects of this embodiment sufficiently by appending at least a part of the moving image obtained by the image pickup unit 130, that is, for example, at least one piece of static image to the second abnormality information.

As described above, in the monitoring system 200 according to this embodiment, the second communication unit 142 is a communication module compatible with the Wi-Fi.

For example, the second abnormality information is transmitted from the second communication unit 142 to the server 600 through the data communication network 500 including the Ethernet line by way of a Wi-Fi router provided at home when the child as the wearer returns home, or by way of a Wi-Fi spot provided in a cram school facility or a commercial facility where the child stays.

Thus, use of the Wi-Fi communications for transmitting the second abnormality information makes it possible to promptly transmit an enormous amount of data to the server 600 through the data communication network 500 without imposing a high cost on the communication charges of the user.

As described above, since the first communication unit 141 is an LPWA communication module, it is able to communicate even outside, and the communication charges are reasonable; however, the communication speed is low, and this is unsuitable for transmission of an enormous amount of data.

On the other hand, the second communication unit 142 is a Wi-Fi communication module that is able to communicate only in a predetermined facility; however, the communication speed is high, and this allows for prompt transmission of an enormous amount of data.

As described above, in the wearable camera 100 according to this embodiment, when it is determined that the wearer is in the abnormal situation, the first communication unit 141 transmits the first abnormality information, which is brief abnormality information, in almost real-time, and thereafter the second communication unit 142 transmits the second abnormality information, which is further detailed data.

Consequently, it is possible to detect and determine the abnormal situation of the wearer more precisely.

In the monitoring system 200 according to this embodiment, the original data of the moving image, the metadata obtained by the detection unit 120, and the like before or after the clock time when it is determined that the wearer is in the abnormal situation by a predetermined time, which are contained in the second abnormality information transmitted by the wearable camera 100, are analyzed.

Consequently, it is possible to sophisticatedly analyze an event corresponding to the abnormal situation of the wearer that is difficult to determine only based on the brief real-time detection and to detect all the foretastes of crime even a small one.

As described above, for example, when it is determined that the wearer is in the abnormal situation corresponding to the abnormality condition A, the abnormality determination unit provided in the control unit 111 determines whether an acceleration obtained by the acceleration sensor 124 is an acceleration equal to or more than a threshold, as indicated in Table 1.

In this process, when the wearer is a child such as an elementary school student, an abnormality that does not become serious, such as falling forward inadvertently, may frequently causes the detection of an acceleration equal to or more than a threshold.

It is bothersome to make notifications to the guardian of the wearer every time a determination result of the abnormality condition A is obtained from such falling, and this may make the guardian unnecessarily worry and put a strain on the guardian who receives the notification.

In view of this, with a threshold of the acceleration in a frontward direction of the wearer being set higher than other directions, it is possible to make no notification of falling that is frequent and has low risk of serious injury while making a notification of serious falling or accident as an abnormality.

Otherwise, the threshold of acceleration may be set to a constant value for all directions, and the first abnormality information may be transmitted to the server application 610 while the maximum acceleration and an acceleration direction are appended thereto in addition to the acceleration obtained by the acceleration sensor 124.

Then, the received first abnormality information may be analyzed by the analysis application 630 to determine the analysis result, and processing of changing the contents of the notification to the guardian may be executed depending on which is higher: the possibility of normal falling or that of a serious accident.

It is also possible to change the processing such that, in the case of determining the abnormality condition A, a plurality of thresholds are set for acceleration to determine the danger level depending on which threshold the acceleration exceeds, and the contents of a notification thereafter is changed accordingly, for example.

For example, when it is determined that the wearer is in the abnormal situation corresponding to the abnormality condition C, the microphone 123 obtains the sound around the wearer, and the sound recognition unit provided in the control unit 111 determines whether the keyword set in advance is detected from the obtained sound data, as indicated in Table 1.

The wearable camera 100 according to this embodiment is provided with a sound recognition chip that can recognize a particular keyword as the sound recognition unit.

Consequently, it is possible to determine the abnormality condition C offline without accessing to the outside through the data communication network 500.

Additionally, with the keyword being registered to the sound recognition unit in advance, it is possible to detect suspicious speaking including such a keyword from a suspicious person to the wearer.

For example, in the wearable camera 100 according to this embodiment, keywords that are likely to lead to crime against children or likely to be spoken by a criminal during committing a crime, such as “Let's go over there”, “Let me give you oo”, “Do you want a ride?”, and “Shut up”, are registered to the sound recognition unit.

The sound recognition unit then detects the registered keyword from the obtained sound data, and when it is determined that there is suspicious speaking, or that the wearer is in the abnormal situation corresponding to the abnormality condition C, a notification is made to the guardian, or an attention is brought to the child as the wearer, as needed.

For the abnormality condition C, it is also possible to make a determination by using a general-purpose sound recognition application provided on the general cloud.

However, since the communication speed of the first communication unit 141 provided in the wearable camera 100 according to this embodiment is insufficient to transmit an enormous amount of data to the cloud, it is difficult to make the determination described above.

In view of this, in the wearable camera 100 according to this embodiment, for the determination on the abnormality condition C, the sound recognition chip as the sound recognition unit that detects only a particular keyword registered in advance is used instead of using the general-purpose sound recognition application on the cloud.

Consequently, loads due to the data communication on the wearable camera 100 are reduced, and accordingly it is possible to reduce the power consumption required for the sound recognition processing.

As described above, in the wearable camera 100 according to this embodiment, a keyword registered in advance is detected by the sound recognition unit provided in the control unit 111 to determine whether the abnormality condition C is satisfied, or whether suspicious speaking occurs.

As indicated in Table 3, only the detected keyword is appended to the first abnormality information while no sound data is appended thereto, and consequently it is possible to reduce the amount of communication data during the transmission of the first abnormality information.

However, the configuration is not limited to the above, and when the communication speed of the first communication unit 141 and the capacity of the battery 161 of the wearable camera 100 are sufficient, the general-purpose sound recognition application on the cloud may be used as the sound recognition unit to detect all words included in the obtained sound data and make a determination.

The processing of determining the abnormality conditions A to L individually is described above; however, it is also possible to determine the conditions compositely to improve the accuracy.

For example, for the abnormality condition H, the number of people around the wearer is detected based on the moving image obtained by the image pickup unit 130, and when the number of the people is smaller than a predetermined number, or it is a lonely place, it is determined that it is a situation where a crime is more likely to occur, or it is the abnormal situation.

On the other hand, for the abnormality condition F, a person shown in the moving image obtained by the image pickup unit 130 is detected, and when the person is shown also after a lapse of a predetermined time, it is determined that it is a situation where a suspicious person is following the wearer, or it is the abnormal situation.

In these determinations, if the situations based on the abnormality conditions H and F are both identified at the same time, there is a high possibility that the wearer is followed by a particular person in a lonely place, and the possibility that the wearer becomes a victim of a crime after the determination becomes higher.

Thus, in the wearable camera 100 according to this embodiment, it is also possible to make processing different between a case where each of the abnormality conditions is individually satisfied and a case where a plurality of abnormality conditions are satisfied at the same time, as described below.

That is, when the situation based on the abnormality condition H or F is identified individually, no first abnormality information is transmitted to the guardian terminal 700 even though the server application 610 receives the first abnormality information, or the first abnormality information is transmitted to the guardian terminal 700 as reference information indicating that the wearer is in a situation of low danger level.

On the other hand, when the situations based on the abnormality conditions H and F are both identified at the same time, after the server application 610 receives the first abnormality information, a notification that the wearer is in a situation of high danger level is immediately transmitted to the guardian terminal 700.

This configuration is applied not only to the example of compositely determining the abnormality conditions H and F as described above, and it is also possible to analyze the danger level of the wearer by making a composite determination based on the data obtained by the plurality of sensors provided in the wearable camera 100 and the plurality of abnormality conditions and to make the processing different depending on the danger level.

For example, when situations based on the abnormality conditions J and K are both identified at the same time, a possibility that the wearer is having poor health such as heatstroke becomes higher, and it is possible to determine that the danger level is much higher than a case where the situation based on the abnormality condition J or K is identified individually.

Additionally, when situations based on the abnormality conditions C, G and H are identified at the same time, it is possible to determine that there is an extremely high possibility that the wearer is followed by a suspicious person in a lonely place.

In the wearable camera 100 according to this embodiment, making a notification to the guardian is described as the main processing to be executed when it is determined that the wearer is in the abnormal situation; however, the configuration is not limited to the above.

For example, when it is determined that the wearer is in the abnormal situation, processing of giving advice to the wearer from the speaker 151, warning the criminal by a warning sound, allowing the guardian to speak to the wearable camera 100 of the wearer from the guardian terminal 700, or the like may be executed.

Otherwise, it is also possible to make a notification to a neighboring volunteer patrolling party and the like for help.

The wearable camera 100 according to this embodiment is, for example, hardware including a camera terminal and the like provided on a base in a shape of necklace and has a form attachable to clothes or bag of the wearer.

A clip portion for fixing the wearable camera 100 on clothes may be provided on the back side of the camera terminal such that the camera terminal faces forward of the wearer.

The wearable camera 100 according to this embodiment may have a form of hardware including an attachment portion attachable to various places such as a breast pocket or back of clothes of the wearer, a belt or the back side of a schoolbag, a handbag for cram school, and the like.

In this case, an application that receives an input of a place where the wearable camera 100 is attached may be provided, and in the determination for the abnormality condition A, for example, whether the child fell down can be determined based on the inputted parameter.

As described above, the wearable camera 100 according to this embodiment includes the first communication unit 141, which transmits brief data to notify of the abnormality detection in real-time when it is determined that the wearer is in the abnormal situation, and the second communication unit 142, which transmits detailed data thereafter to execute sophisticated analysis and detect a danger with a high degree of accuracy.

Consequently, it is possible to provide a wearable camera and a security system including the wearable camera that can obtain a particular effect of image obtainment and the promptness in times of emergency and can achieve a reduction in both the power consumption and the communication amount.

A preferable embodiment is described above; however, the configuration is not limited to the embodiment, and various modifications and changes can be made without departing from the gist.

According to the present invention, it is possible to provide a wearable camera that can suppress an increase in the power consumption and a degradation in throughput.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-089313, filed May 22, 2020, which is hereby incorporated by reference herein in its entirety.

What is claimed is:

1. A wearable camera, comprising:
an image pickup unit configured to obtain moving image data of an object;
a detection unit configured to obtain detection data;
a control unit configured to determine whether a wearer is in an abnormal situation based on the moving image data and the detection data and generate attribute tag data including a determination clock time and details of abnormality when it is determined that the wearer is in an abnormal situation;
a first communication unit configured to transmit first information to a server when the control unit determines that the wearer is in an abnormal situation; and
a second communication unit configured to transmit second information including the moving image data and having a greater amount of data than that of the first information to the server based on the attribute tag data.

2. The wearable camera according to claim 1, wherein the first information includes information on a location and an identification of the wearable camera when the control unit determines that the wearer is in an abnormal situation.

3. The wearable camera according to claim 1, wherein the second information includes information that is not included in the first information.

4. The wearable camera according to claim 1, wherein the second information includes information that is obtained at clock times before and after when the control unit determines that the wearer is in an abnormal situation.

5. The wearable camera according to claim 1, wherein a maximum communication speed of the second communication unit is greater than that of the first communication unit.

6. The wearable camera according to claim 1, wherein the first information includes a static image obtained from the moving image data.

7. The wearable camera according to claim 1, wherein the first information differs depending on the details of abnormality.

8. The wearable camera according to claim 1, wherein the second information differs depending on the details of abnormality.

9. The wearable camera according to claim 1, wherein
the control unit compares a plurality of the attribute tag data with each other to generate attribute tag data for which priorities are set, and
the second communication unit transmits the second information to the server based on the attribute tag data for which priorities are set.

10. A security system, comprising:
the wearable camera according to claim 1;
the server including a server application that receives the first and second information from the wearable camera and an analysis application that analyzes the moving image data; and
a reception unit configured to receive a notification indicating that the wearer is in the abnormal situation.

11. The security system according to claim 10, wherein
the server application transmits the notification to the reception unit when receiving the first information, and
the server application causes the analysis application to analyze the moving image data included in the second information when receiving the second information.
